(19) United States
(12) Patent Application Publication
(10) Pub. No.: US 2026/0302841 A1
(43) Pub. Date: Oct. 1, 2026

(54) MOLDED STATOR AND MOTOR

(71) Applicant: Resonac Corporation, Minato-ku, Tokyo (JP)

(72) Inventors: Shinichiro FUJITA, Minato-ku, Tokyo (JP); Akifumi TAMURA, Minato-ku, Tokyo (JP)

(73) Assignee: Resonac Corporation, Minato-ku, Tokyo (JP)

(21) Appl. No.: 19/479,178

(22) PCT Filed: Oct. 17, 2024
(86) PCT No.: PCT/JP2024/037017

§ 371 Date: Oct. 27, 2025

(30) Foreign Application Priority Data
Dec. 13, 2023 (JP) 2023-210350

(51) Int. Cl. H02K 1/04; C08L 25/06; C08L 67/06

(52) U.S. Cl. CPC H02K 1/04; C08L 25/06; C08L 67/06; C08L 2205/025; C08L 2205/03; C08L 2205/035

(57) ABSTRACT

A molded stator includes: a stator including a stator core and a coil wound on the stator core; and a molding material covering the stator, in which the molding material is a cured product of a thermosetting resin composition containing a saturated polyester resin (A), an unsaturated polyester resin (B), an ethylenically unsaturated monomer (C), a thermal polymerization initiator (D), a glass fiber (E), and an inorganic filler (F), in which: the unsaturated polyester resin (B) includes at least an unsaturated polyester resin (B-1); the unsaturated polyester resin (B-1) is a polycondensate of a mixture containing a diol and an unsaturated polybasic acid; and the unsaturated polyester resin (B-1) has a structure derived from propylene glycol and a structure derived from neopentyl glycol.

### TECHNICAL FIELD

The present disclosure pertains to a molded stator, a motor including the molded stator, and a thermosetting resin composition.

### BACKGROUND ART

There is a growing demand for smaller, thinner, lighter, and higher-output motors and transformers for home appliances. In addition, due to the characteristics of the operating environment of such appliances, they are required to exhibit low noise and low vibration.

To meet this demand, a structure has been proposed in which an electromagnetic coil wound on a stator core is covered with molding resin (PTL 1).

### CITATION LIST

### Patent Literature

PTL 1: Japanese Unexamined Patent Application Publication No. 2023-091064 (JP 2023-091064 A)

### SUMMARY OF INVENTION

### Technical Problem

In molding so that a stator is covered with molding resin, a thin-walled portion and a thick-walled portion are generated in a cured product of the molding resin as the shape of the stator becomes more complex. In addition, there is a need to reduce the amount of molding resin to the utmost to make the stator thinner and lighter. As a result, the strength of the cured product of the molding resin becomes insufficient, causing cracks to occur in a molded article.

The present disclosure provides a molded stator covered with a molding material having a crack-free, good appearance.

### Solution to Problem

The present disclosure includes the following aspects.
[1] A molded stator including:
a stator including a stator core and a coil wound on the stator core; and
a molding material covering the stator,
wherein the molding material is a cured product of a thermosetting resin composition containing a saturated polyester resin (A), an unsaturated polyester resin (B), an ethylenically unsaturated monomer (C), a thermal polymerization initiator (D), a glass fiber (E), and an inorganic filler (F), wherein:
the unsaturated polyester resin (B) includes at least an unsaturated polyester resin (B-1);
the unsaturated polyester resin (B-1) is a polycondensate of a mixture including a diol and an unsaturated polybasic acid; and
the unsaturated polyester resin (B-1) has a structure derived from propylene glycol and a structure derived from neopentyl glycol.
[2] The molded stator according to [1], wherein a content ratio (molar ratio) of the structure derived from propylene glycol to the structure derived from neopentyl glycol in the unsaturated polyester resin (B-1) is from 10:90 to 90:10.
[3] The molded stator according to [1] or [2], wherein the unsaturated polyester resin (B-1) further has a structure derived from hydrogenated bisphenol A.
[4] The molded stator according to any one of [1] to [3], wherein:
the unsaturated polyester resin (B) further includes an unsaturated polyester resin (B-2);
the unsaturated polyester resin (B-2) is a polycondensate of a mixture including a diol and an unsaturated polybasic acid; and
the unsaturated polyester resin (B-2) has a structure derived from propylene glycol but does not have a structure derived from neopentyl glycol.
[5] The molded stator according to any one of [1] to [4], wherein the unsaturated polyester resin (B-1) has a structure derived from a saturated polybasic acid.
[6] The molded stator according to [4], wherein the unsaturated polyester resin (B-2) has a structure derived from a saturated polybasic acid.
[7] The molded stator according to any one of [1] to [6], wherein the unsaturated polyester resin (B-1) has a weight-average molecular weight of 10000 to 50000.
[8] The molded stator according to any one of [1] to [7], wherein:
the unsaturated polyester resin (A) is a polycondensate of a mixture containing a diol and a saturated polybasic acid; and
the saturated polybasic acid includes an aromatic saturated polybasic acid or an acid anhydride thereof, and an aliphatic saturated polybasic acid.
[9] The molded stator according to [8], wherein:
in the saturated polyester resin (A), a content ratio (molar ratio) of a structure derived from the aromatic saturated polybasic acid or an acid anhydride thereof to a structure derived from the aliphatic saturated polybasic acid is from 20:80 to 80:20, and
the saturated polyester resin (A) includes a block (X) that is a polycondensate of a diol and the aromatic saturated polybasic acid or an acid anhydride thereof; and a block (Y) that is a polycondensate of a diol and the aliphatic saturated polybasic acid, the block (X) having a weight-average molecular weight of 3000 to 5000.
[10] The molded stator according to [9], wherein the aromatic saturated polybasic acid constituting the block (X) is at least one selected from isophthalic acid and terephthalic acid.
[11] The molded stator according to [9] or [10], wherein the aliphatic saturated polybasic acid constituting the block (Y) is at least one selected from succinic acid, adipic acid, and sebacic acid.
[12] The molded stator according to any one of [1] to [11], wherein the saturated polyester resin (A) has a weight-average molecular weight of 9500 to 13500.
[13] The molded stator according to any one of [1] to [12], wherein the thermosetting resin composition includes, based on a total amount of 100 parts by mass of the unsaturated polyester resin (B) and the ethylenically unsaturated monomer (C):
the saturated polyester resin (A) in an amount of 5 parts by mass to 30 parts by mass;
the unsaturated polyester resin (B) in an amount of 20 parts by mass to 80 parts by mass;
the ethylenically unsaturated monomer (C) in an amount of 80 parts by mass to 20 parts by mass;
the thermal polymerization initiator (D) in an amount of 0.5 parts by mass to 20 parts by mass;
the glass fiber (E) in an amount of 5 parts by mass to 150 parts by mass; and
the inorganic filler (F) in an amount of 50 parts by mass to 1000 parts by mass.
[14] A motor including:
the molded stator according to any one of [1] to [13];
a rotor disposed inside the stator, the rotor including a rotary shaft configured to extend in a shaft center direction and a rotation body configured to contain a magnet component, to extend in the shaft center direction, and to be fixed to the rotary shaft; and
a bearing configured to rotatably support the rotor.
[15] A thermosetting resin composition including:
a saturated polyester resin (A);
an unsaturated polyester resin (B);
an ethylenically unsaturated monomer (C);
a thermal polymerization initiator (D);
a glass fiber (E); and
an inorganic filler (F), wherein:
the unsaturated polyester resin (B) includes at least an unsaturated polyester resin (B-1);
the unsaturated polyester resin (B-1) is a polycondensate of a mixture including a diol and an unsaturated polybasic acid; and
the unsaturated polyester resin (B-1) has a structure derived from propylene glycol and a structure derived from neopentyl glycol.
[16] The thermosetting resin composition according to [15], wherein the unsaturated polyester resin (B-1) further has a structure derived from hydrogenated bisphenol A.
[17] The thermosetting resin composition according to or [16], wherein:
the unsaturated polyester resin (A) is a polycondensate of a mixture including a diol and a saturated polybasic acid;
the saturated polybasic acid includes an aromatic saturated polybasic acid or an acid anhydride thereof, and an aliphatic saturated polybasic acid;
in the saturated polyester resin (A), a content ratio (molar ratio) of a structure derived from the aromatic saturated polybasic acid or an acid anhydride thereof to a structure derived from the aliphatic saturated polybasic acid is from 20:80 to 80:20; and
the saturated polyester resin (A) includes a block (X) that is a polycondensate of a diol and the aromatic saturated polybasic acid or an acid anhydride thereof; and a block (Y) that is a polycondensate of a diol and the aliphatic saturated polybasic acid, the block (X) having a weight-average molecular weight of 3000 to 5000.
[18] The thermosetting resin composition according to any one of to [17], including, based on a total amount of 100 parts by mass of the unsaturated polyester resin (B) and the ethylenically unsaturated monomer (C):
the saturated polyester resin (A) in an amount of 5 parts by mass to 30 parts by mass;
the unsaturated polyester resin (B) in an amount of 20 parts by mass to 80 parts by mass;
the ethylenically unsaturated monomer (C) in an amount of 80 parts by mass to 20 parts by mass;
the thermal polymerization initiator (D) in an amount of 0.5 parts by mass to 20 parts by mass;
the glass fiber (E) in an amount of 5 parts by mass to 150 parts by mass; and
the inorganic filler (F) in an amount of 50 parts by mass to 1000 parts by mass.
[19] A molding material which is a cured product of the thermosetting resin composition according to any [15] to [18].

### Advantageous Effects of Invention

According to the present disclosure, it is possible to provide a molded stator covered with a molding material having a crack-free, good appearance.

### BRIEF DESCRIPTION OF DRAWING

FIG. 1 is a schematic sectional view of an illustrative motor.

### DESCRIPTION OF EMBODIMENTS

Hereinafter, embodiments of the present invention will be described in detail. However, the present invention is not limited to the embodiments described below.

In the present specification, when a numerical range is expressed using “to”, the numerical values at both ends are inclusive as the upper limit and the lower limit. When a plurality of upper or lower limits is given, numerical ranges can be created from all combinations of the upper and lower limits. Similarly, when a plurality of numerical ranges are given, separate numerical ranges can be created by individually selecting and combining the upper and lower limits from the numerical ranges.

As used herein, the term “(meth)acrylic acid” means methacrylic acid or acrylic acid, the term “(meth)acrylate” means acrylate or methacrylate, and the term “(meth)acryloyloxy” means acryloyloxy or methacryloyloxy.

As used herein, the term “thermosetting resin” refers to a resin that cures by forming a cross-linked structure when heated and indicates the resin in a state before curing.

As used herein, the term “ethylenically unsaturated bond” means a double bond formed between carbon atoms excluding carbon atoms forming an aromatic ring, and the term “ethylenically unsaturated monomer” means a monomer having an ethylenically unsaturated bond.

As used herein, the terms “weight-average molecular weight” and “number-average molecular weight” refer to values measured at normal temperature (23° C.) under the following conditions by gel permeation chromatography (GPC) and determined using a standard polystyrene calibration curve.
Apparatus: Shodex (TM) GPC-101 (Resonac Corporation)
Column: Shodex (TM) LF-804 (Resonac Corporation)
Column temperature: 40° C.
Sample: 0.2% by mass tetrahydrofuran solution of sample
Flow rate: 1 mL/min
Eluent: tetrahydrofuran
Detector: Shodex (TM) RI-71S (Resonac Corporation)

As used herein, the term “acid value” refers to the acid value measured in accordance with JIS K 6901:2021, 5.3. That is, the acid value means the number of milligrams of potassium hydroxide required to neutralize acidic components contained in 1 g of non-volatile matter, excluding solvent.

### <Motor>

A motor is a device that generates electromagnetic force by applying current to an internal coil and produces rotational force through repulsive or attractive force with a permanent magnet or an electromagnet provided on or around the main shaft. Generally, a motor includes a stator including a stator core and a coil wound on the stator core, and a rotation body containing a magnetic component. A motor in which the stator is covered with a molding material is also referred to as a molded motor. In the present specification, a stator covered with a molding material is referred to as a molded stator.

In one embodiment, the motor includes a molded stator; a rotor disposed inside the stator, the rotor including a rotary shaft configured to extend in a shaft center direction and a rotation body configured to contain a magnet component, to extend in the shaft center direction, and to be fixed to the rotary shaft; and a bearing configured to rotatably support the rotor.

In the motor, the molding material constituting the molded stator is a cured product of a thermosetting resin composition described later. In the motor, as a configuration other than the molding material, a known configuration can be adopted.

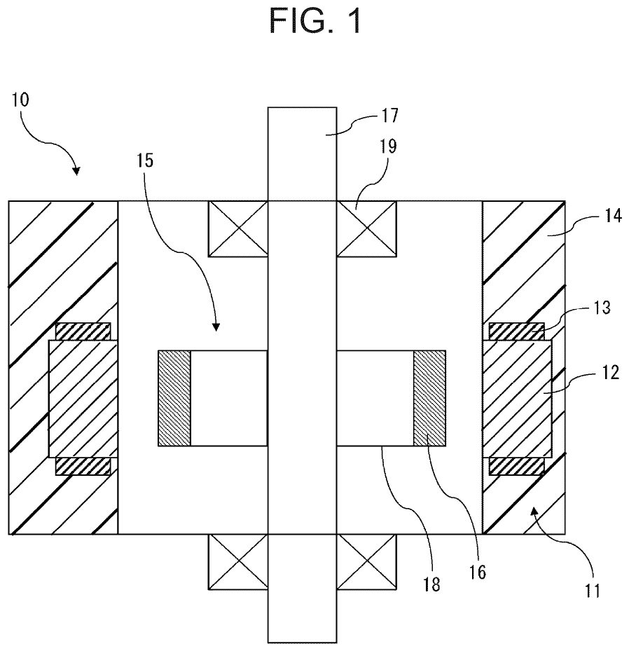

FIG. 1 shows a sectional view of an illustrative motor. In FIG. 1, detailed parts such as a bracket and an insulator attached to the coil are omitted. In FIG. 1, a motor 10 includes a stator 11, a rotor 15, and a bearing 19 configured to rotatably support the rotor 15. The stator 11 includes a stator core 12, which is composed of a plurality of metal plates, and a coil 13 obtained by winding a wire around the stator core 12. The stator 11 is covered with a molding material 14. The rotor 15 is disposed inside the stator 11. The rotor 15 includes a rotary shaft 17 configured to extend in a shaft center direction and a rotation body 18 configured to be fixed to the rotary shaft 17, the rotation body 18 including a magnet 16.

### <Molded Stator>

The molded stator is a stator covered with a molding material. In one embodiment, the molded stator includes a stator including a stator core and a coil wound on the stator core; and a molding material covering the stator. Note that the entire stator does not need to be covered with the molding material.

The molding material constituting the molded stator is a cured product of a thermosetting resin composition described later. In the molded stator, as a configuration other than the molding material, a known configuration can be adopted. The motor to which the molded stator is applied is not particularly limited, and a known motor can be adopted.

### <Molding Material>

The molding material is a cured product of a thermosetting resin composition described later. By using the molding material, a motor with low noise and low vibration can be obtained.

### <Thermosetting Resin Composition>

In one embodiment, the thermosetting resin composition includes a saturated polyester resin (A), an unsaturated polyester resin (B), an ethylenically unsaturated monomer (C), a thermal polymerization initiator (D), a glass fiber (E), and an inorganic filler (F), in which the unsaturated polyester resin (B) includes at least an unsaturated polyester resin (B-1), the unsaturated polyester resin (B-1) is a polycondensate of a mixture containing a diol and an unsaturated polybasic acid, and the unsaturated polyester resin (B-1) has a structure derived from propylene glycol and a structure derived from neopentyl glycol. The cured product of the thermosetting resin composition is suitable for a molding material covering the stator. By using a cured product of a thermosetting resin composition containing the unsaturated polyester resin (B-1) having a specific structure as a molding material, a molded stator having a good appearance without cracks can be obtained. Furthermore, a molded stator with excellent durability against thermal cycling can be obtained.

### [Saturated Polyester Resin (A)]

The saturated polyester resin (A) is a polycondensate of a polyhydric alcohol and a saturated polybasic acid. The saturated polyester resin (A) is preferably a polycondensate of a mixture containing a diol and a saturated polybasic acid, and more preferably a polycondensate of a mixture containing a diol, an aromatic saturated polybasic acid or an acid anhydride thereof, and an aliphatic saturated polybasic acid. In the polyhydric alcohol-derived structure of the saturated polyester resin (A), the structure derived from a diol preferably accounts for 95 mol % or more, more preferably 98 mol % or more, and still more preferably 100 mol %. In the polyhydric alcohol-derived structure of the saturated polyester resin (A), the upper limit of the structure derived from a diol may be 100 mol % or 99 mol %. In the saturated polybasic acid-derived structure of the saturated polyester resin (A), the structure derived from at least one of an aromatic saturated polybasic acid, an acid anhydride thereof, and an aliphatic saturated polybasic acid preferably accounts for 95 mol % or more, more preferably 98 mol % or more, and still more preferably 100 mol %. In the saturated polybasic acid-derived structure of the saturated polyester resin (A), the upper limit of the structure derived from at least one of an aromatic saturated polybasic acid, an acid anhydride thereof, and an aliphatic saturated polybasic acid may be 100 mol % or 99 mol %.

The saturated polyester resin (A) may be used singly or in combination of two or more thereof. The use of the saturated polyester resin (A) reduces the occurrence of cracks during molding.

In the present disclosure, a styrene monomer or the like contained in a commercially available saturated polyester resin is classified into an ethylenically unsaturated monomer (C).

The polyhydric alcohol is not particularly limited if it is a compound having two or more hydroxy groups. The polyhydric alcohol is preferably at least one selected from the group consisting of a diol and a triol, and more preferably a diol. Examples of the polyhydric alcohol include: alkylene glycols, such as ethylene glycol, propylene glycol, butanediol, pentanediol, hexanediol, neopentyl glycol, 2-methyl-1,3-propanediol, 1,4-cyclohexanedimethanol, and hydrogenated bisphenol A; polyoxyalkylene polyols, such as diethylene glycol, dipropylene glycol, triethylene glycol, tetraethylene glycol, and polyethylene glycol; bisphenol A; alkylene oxide-modified bisphenol A, such as an ethylene oxide adduct of bisphenol A and a propylene oxide adduct of bisphenol A; and glycerin. From the viewpoint of crack resistance during molding, the polyhydric alcohol is preferably at least one selected from the group consisting of alkylene glycol and polyoxyalkylene polyol, more preferably polyoxyalkylene glycol, and still more preferably at least one selected from diethylene glycol, dipropylene glycol, and triethylene glycol. From the viewpoint of improving the durability of the molded article, it is preferable to use polyoxyethylene glycol in combination with polyoxypropylene glycol and more preferable to use diethylene glycol in combination with dipropylene glycol. The content ratio (molar ratio) of polyoxyethylene glycol to polyoxypropylene glycol or the content ratio (molar ratio) of diethylene glycol to dipropylene glycol is not particularly limited, but is preferably from 40:60 to 80:20, more preferably from 50:50 to 70:30, still more preferably from 55:45 to 65:35, and particularly preferably from 58:42 to 63:37 from the viewpoint of improving durability. The polyhydric alcohol may be used singly or in combination of two or more thereof.

The saturated polybasic acid is not particularly limited if it is a compound lacking an ethylenically unsaturated bond and having two or more carboxy groups, or an acid anhydride thereof, and a known saturated polybasic acid can be used. The saturated polybasic acid is preferably a saturated dibasic acid. Examples of the saturated polybasic acid include aromatic saturated polybasic acids or acid anhydrides thereof, such as phthalic acid, phthalic anhydride, isophthalic acid, terephthalic acid, tetrachlorophthalic anhydride, tetrabromophthalic anhydride, nitrophthalic acid, and halogenated phthalic anhydride; aliphatic saturated polybasic acids, such as succinic acid, adipic acid, sebacic acid, oxalic acid, malonic acid, azelaic acid, and glutaric acid; and acid anhydrides of saturated alicyclic polybasic acids, such as hexahydrophthalic anhydride. The aromatic saturated polybasic acid or an acid anhydride thereof is preferably at least one selected from the group consisting of an aromatic saturated dibasic acid and an acid anhydride thereof, more preferably at least one selected from phthalic acid, phthalic anhydride, isophthalic acid, and terephthalic acid, and still more preferably at least one selected from isophthalic acid and terephthalic acid. The aliphatic saturated polybasic acid is preferably an aliphatic saturated dibasic acid, more preferably an aliphatic saturated dibasic acid having 4 to 10 carbon atoms, and still more preferably at least one selected from succinic acid, adipic acid, and sebacic acid. From the viewpoint of crack resistance during molding, it is preferable to use at least one selected from the group consisting of an aromatic saturated polybasic acid, an acid anhydride thereof, and an aliphatic saturated polybasic acid, more preferable to use an aromatic saturated polybasic acid or an acid anhydride thereof in combination with an aliphatic saturated polybasic acid, and still more preferable to use at least one selected from isophthalic acid and terephthalic acid in combination with at least one selected from succinic acid, adipic acid, and sebacic acid. The saturated polybasic acid may be used singly or in combination of two or more thereof.

When the aromatic saturated polybasic acid or an acid anhydride thereof is used in combination with the aliphatic saturated polybasic acid, the proportion of the aromatic saturated polybasic acid or an acid anhydride thereof to the total amount thereof is preferably 20 mol % or more, more preferably 30 mol % or more, and still more preferably 40 mol % or more. When the aromatic saturated polybasic acid or an acid anhydride thereof is used in combination with the aliphatic saturated polybasic acid, the proportion of the aromatic saturated polybasic acid or an acid anhydride thereof to the total amount thereof is preferably 80 mol % or less, more preferably 70 mol % or less, and still more preferably 60 mol % or less. When the proportion of the aromatic saturated polybasic acid or an acid anhydride thereof is within the above range, the moldability is improved, and the properties of the cured product can be further enhanced.

When the aromatic saturated polybasic acid or an acid anhydride thereof is used in combination with the aliphatic saturated polybasic acid, the proportion of the aliphatic saturated polybasic acid to the total amount thereof is preferably 20 mol % or more, more preferably 30 mol % or more, and still more preferably 40 mol % or more. When the aromatic saturated polybasic acid or an acid anhydride thereof is used in combination with the aliphatic saturated polybasic acid, the proportion of the aliphatic saturated polybasic acid to the total amount thereof is preferably 80 mol % or less, more preferably 70 mol % or less, and still more preferably 60 mol % or less. When the proportion of the aliphatic saturated polybasic acid is within the above range, the crack resistance can be further improved.

When the aromatic saturated polybasic acid or an anhydride thereof is used in combination with the aliphatic saturated polybasic acid, the content ratio (molar ratio) of the structure derived from the aromatic saturated polybasic acid or an anhydride thereof to the structure derived from the aliphatic saturated polybasic acid in the saturated polyester resin (A) is preferably from 20:80 to 80:20, more preferably from 30:70 to 70:30, and still more preferably from 40:60 to 60:40.

When the aromatic saturated polybasic acid or an anhydride thereof is used in combination with the aliphatic saturated polybasic acid, the structure derived therefrom may be uniformly dispersed in the molecule of the saturated polyester resin (A) or may be unevenly distributed in the molecule. From the viewpoint of crack resistance during molding, the saturated polyester resin (A) preferably includes a block (X) that is a polycondensate of a diol and the aromatic saturated polybasic acid or an acid anhydride thereof, the block (X) having a weight-average molecular weight of 3000 to 5000; and a block (Y) that is a polycondensate of a diol and the aliphatic saturated polybasic acid. In the saturated polyester resin (A) containing the block (X) and the block (Y), the content ratio (molar ratio) of the structure derived from the aromatic saturated polybasic acid or an anhydride thereof to the structure derived from the aliphatic saturated polybasic acid is preferably from 20:80 to 80:20, more preferably from 30:70 to 70:30, and still more preferably from 40:60 to 60:40.

In the saturated polyester resin (A) containing the block (X) and the block (Y), a structure derived from an aromatic saturated polybasic acid or an acid anhydride thereof may be interspersed in a portion other than the block (X) and the block (Y).

The weight-average molecular weight of the block (X) is preferably 3000 or more, and more preferably 3500 or more. The weight-average molecular weight of the block (X) is preferably 5000 or less, and more preferably 4500 or less. When the weight-average molecular weight of the block (X) is within the above range, the crack resistance during molding is further improved.

The aromatic saturated polybasic acid or the acid anhydride thereof constituting the block (X) is preferably at least one selected from the group consisting of aromatic saturated dibasic acids and acid anhydrides thereof, more preferably at least one selected from phthalic acid, phthalic anhydride, isophthalic acid, and terephthalic acid, and still more preferably at least one selected from isophthalic acid and terephthalic acid.

The aliphatic saturated polybasic acid constituting the block (Y) is preferably an aliphatic saturated dibasic acid, more preferably an aliphatic saturated dibasic acid having 4 to 10 carbon atoms, and more preferably at least one selected from succinic acid, adipic acid, and sebacic acid.

A preferred combination of the polyhydric alcohol and the saturated polybasic acid is a diol and a saturated dibasic acid, and a more preferred combination is a polyoxyalkylene glycol and a saturated dibasic acid. More specific examples thereof include a combination of diethylene glycol and isophthalic acid, a combination of diethylene glycol and adipic acid, a combination of dipropylene glycol and isophthalic acid, a combination of dipropylene glycol and adipic acid, a combination of diethylene glycol, isophthalic acid, and adipic acid, a combination of dipropylene glycol, isophthalic acid, and adipic acid, and a combination of diethylene glycol, dipropylene glycol, isophthalic acid, and adipic acid. Among them, a combination of diethylene glycol, isophthalic acid, and adipic acid, a combination of dipropylene glycol, isophthalic acid, and adipic acid, and a combination of diethylene glycol, dipropylene glycol, isophthalic acid, and adipic acid are particularly favorable in terms of crack resistance during molding, and are therefore preferable.

The weight-average molecular weight of the saturated polyester resin (A) is preferably 9500 or more, more preferably 9800 or more, and still more preferably 10000 or more. The weight-average molecular weight of the saturated polyester resin (A) is preferably 13500 or less, more preferably 13000 or less, and still more preferably 12500 or less. When the weight-average molecular weight is in the above range, the occurrence of cracks during molding is further reduced. Without being bound by any theory, it is considered that setting the weight-average molecular weight of the saturated polyester resin (A) within the above range improves the compatibility with the unsaturated polyester resin (B) and the dispersibility of components (C) to (F), thereby further reducing the occurrence of cracks during molding. The weight-average molecular weight of the saturated polyester resin (A) can be adjusted by the reaction time in synthesizing the saturated polyester resin (A). Specifically, the longer the reaction time, the greater the weight-average molecular weight, and the shorter the reaction time, the smaller the weight-average molecular weight.

The content of the saturated polyester resin (A) in the thermosetting resin composition is preferably 5 parts by mass or more, more preferably 8 parts by mass or more, and still more preferably 10 parts by mass or more, based on 100 parts by mass of the total amount of the unsaturated polyester resin (B) and the ethylenically unsaturated monomer (C). The content of the saturated polyester resin (A) in the thermosetting resin composition is preferably 30 parts by mass or less, and more preferably 25 parts by mass or less, based on 100 parts by mass of the total amount of the unsaturated polyester resin (B) and the ethylenically unsaturated monomer (C). The content of the saturated polyester resin (A) in the thermosetting resin composition is preferably from 5 parts by mass to 30 parts by mass, more preferably from 8 parts by mass to 25 parts by mass, and still more preferably from 10 parts by mass to 20 parts by mass, based on 100 parts by mass of the total amount of the unsaturated polyester resin (B) and the ethylenically unsaturated monomer (C). When the content of the saturated polyester resin (A) in the thermosetting resin composition is 5 parts by mass or more, the occurrence of cracks during molding can be further reduced. When the content of the saturated polyester resin (A) in the thermosetting resin composition is 30 parts by mass or less, the moldability of the thermosetting resin composition and the mechanical properties of the cured product are further improved.

### (Method for Synthesizing Saturated Polyester Resin (A))

The saturated polyester resin (A) can be synthesized by a known method using the above-described raw materials. Various conditions in the synthesis of the saturated polyester resin (A) are appropriately set depending on the raw materials used and the amounts thereof.

Generally, an esterification reaction can be conducted in a stream of an inert gas such as nitrogen gas at a temperature of 140° C. to 230° C. under pressure or reduced pressure. In the esterification reaction, an esterification catalyst can be used, if necessary. Examples of the esterification catalyst include known catalysts such as manganese acetate, dibutyltin oxide, stannous oxalate, zinc acetate, and cobalt acetate. The esterification catalyst may be used singly or in combination of two or more thereof.

The equivalent amount of hydroxyl groups in the polyhydric alcohol based on the total amount of carboxy groups in the saturated polybasic acid is preferably in the range of 0.9 to 1.2.

When an aromatic saturated polybasic acid or an acid anhydride thereof is used in combination with an aliphatic saturated polybasic acid, the structures derived therefrom may be uniformly dispersed and contained in the molecule of the saturated polyester resin (A). Such a saturated polyester resin (A) can be obtained by adding both into a reaction vessel at once and performing an esterification reaction.

From the viewpoint of crack resistance during molding, the structure derived from an aromatic saturated polybasic acid or an acid anhydride thereof and the structure derived from an aliphatic saturated polybasic acid are each unevenly distributed in the molecule. Such a saturated polyester resin (A) can be obtained by first charging one of the saturated polybasic acids into a reaction vessel, allowing the esterification reaction to proceed, and when a certain amount of the saturated polybasic acid is consumed, charging the other saturated polybasic acid into the reaction vessel allows the esterification reaction to proceed until a desired weight-average molecular weight is obtained. For example, such a saturated polyester resin (A) can be synthesized as follows: a polyhydric alcohol in an amount equivalent to the total amount of an aromatic saturated polybasic acid or an acid anhydride thereof and an aliphatic saturated polybasic acid is first charged together with an aromatic saturated polybasic acid or an acid anhydride thereof into a reaction vessel to allow an esterification reaction to proceed, and when a certain amount of the aromatic saturated polybasic acid or an acid anhydride thereof is consumed, the aliphatic saturated polybasic acid is charged into the reaction vessel to allow the esterification reaction to proceed.

For example, the saturated polyester resin (A) including a block (X) that is a polycondensate of a diol and the aromatic saturated polybasic acid or an acid anhydride thereof; and a block (Y) that is a polycondensate of a diol and the aliphatic saturated polybasic acid can be synthesized as follows: a diol in an amount equivalent to the total amount of an aromatic saturated polybasic acid or an acid anhydride thereof and an aliphatic saturated polybasic acid is first charged together with an aromatic saturated polybasic acid or an acid anhydride thereof into a reaction vessel to allow an esterification reaction to proceed, and when a certain amount of the aromatic saturated polybasic acid or an acid anhydride thereof is consumed, an aliphatic saturated polybasic acid is charged into the reaction vessel to allow the esterification reaction to proceed.

The weight-average molecular weight of the block (X) can be adjusted by the timing of addition of the aliphatic saturated polybasic acid to be added later. For example, the acid value of the reaction solution, that is, the residual amount of the aromatic saturated polybasic acid or an acid anhydride thereof added in advance may be traced, and the aliphatic saturated polybasic acid may be added when the residual amount reaches a desired level. From the viewpoint of crack resistance, the acid value of the reaction solution at the time of addition of the aliphatic saturated polybasic acid is preferably 30 KOH mg/g or less, more preferably 20 KOH mg/g or less, and still more preferably 10 KOH mg/g or less. The acid value of the reaction solution at the time of addition of the aliphatic saturated polybasic acid may be 1 KOH mg/g or more, 3 KOH mg/g or more, or 5 KOH mg/g or more.

### [Unsaturated Polyester Resin (B)]

The unsaturated polyester resin (B) is a polycondensate of a polyhydric alcohol and an unsaturated polybasic acid or a polycondensate of a polyhydric alcohol, an unsaturated polybasic acid, and a saturated polybasic acid. The unsaturated polyester resin (B) includes at least an unsaturated polyester resin (B-1), the unsaturated polyester resin (B-1) is a polycondensate of a mixture containing a diol and an unsaturated polybasic acid, and the unsaturated polyester resin (B-1) has a structure derived from propylene glycol and a structure derived from neopentyl glycol. The unsaturated polyester resin (B) may further include an unsaturated polyester resin (B-2), the unsaturated polyester resin (B-2) is a polycondensate of a mixture containing a diol and an unsaturated polybasic acid, and the unsaturated polyester resin (B-2) has a structure derived from propylene glycol but does not have a structure derived from neopentyl glycol. The unsaturated polyester resin (B) includes an unsaturated polyester resin other than (B-1) and (B-2). By using the unsaturated polyester resin (B), a cured product having excellent mechanical strength and heat resistance can be obtained.

In the present disclosure, a styrene monomer or the like contained in a commercially available unsaturated polyester resin is classified into an ethylenically unsaturated monomer (C).

The content of the unsaturated polyester resin (B-1) in the unsaturated polyester resin (B) is preferably 75% by mass or more, more preferably 80% by mass or more, and still more preferably 90% by mass or more. When the content of the unsaturated polyester resin (B-1) is 75% by mass or more, appropriate moldability, fluidity, and curing shrinkage can be achieved. The upper limit of the content of the unsaturated polyester resin (B-1) in the unsaturated polyester resin (B) is not particularly limited. For example, the content may be 100% by mass, 97% by mass, or 95% by mass.

When the unsaturated polyester resin (B-1) is used in combination with the unsaturated polyester resin (B-2), the total content of the unsaturated polyester resin (B-1) and the unsaturated polyester resin (B-2) in the unsaturated polyester resin (B) is preferably 75% by mass or more, more preferably 80% by mass or more, and still more preferably 90% by mass or more. When the total content of the unsaturated polyester resin (B-1) and the unsaturated polyester resin (B-2) is 75% by mass or more, appropriate moldability, fluidity, and curing shrinkage can be achieved. The upper limit of the total content of the unsaturated polyester resin (B-1) and the unsaturated polyester resin (B-2) in the unsaturated polyester resin (B) is not particularly limited. For example, the content may be 100% by mass, 97% by mass, or 95% by mass.

When the unsaturated polyester resin (B-1) is used in combination with the unsaturated polyester resin (B-2), the proportion of the unsaturated polyester resin (B-1) to the total of the unsaturated polyester resin (B-1) and the unsaturated polyester resin (B-2) is preferably from 20% by mass to 80% by mass, more preferably 30% by mass to 70% by mass, and still more preferably 40% by mass to 60% by mass.

In another aspect, the content of the unsaturated polyester resin (B-1) in the unsaturated polyester resin (B) is preferably 10% by mass or more, more preferably 20% by mass or more, and still more preferably 30% by mass or more. The content of the unsaturated polyester resin (B-1) in the unsaturated polyester resin (B) is preferably 80% by mass or less, more preferably 70% by mass or less, and still more preferably 60% by mass or less. The content of the unsaturated polyester resin (B-2) in the unsaturated polyester resin (B) is preferably 1% by mass or more, more preferably 5% by mass or more, and still more preferably 10% by mass or more. The content of the unsaturated polyester resin (B-2) in the unsaturated polyester resin (B) is preferably 80% by mass or less, more preferably 70% by mass or less, and still more preferably 60% by mass or less.

The weight-average molecular weight of the unsaturated polyester resin (B) is preferably from 2,000 to 50,000, more preferably from 5,000 to 50,000, still more preferably from 10,000 to 50,000, and even more preferably from 13,000 to 35,000. When the weight-average molecular weight is within the above range, the occurrence of cracks during molding is further reduced. Without being bound by any theory, it is considered that setting the weight-average molecular weight of the unsaturated polyester resin (B) within the above range improves the compatibility with the saturated polyester resin (A) and the dispersibility of components (C) to (F), thereby further reducing the occurrence of cracks during molding. Note that the weight-average molecular weight of the unsaturated polyester resin (B) refers to the weight-average molecular weight of the resin in a state before curing.

The content of the unsaturated polyester resin (B) in the thermosetting resin composition is preferably 20 parts by mass or more, more preferably 30 parts by mass or more, and still more preferably 40 parts by mass or more, based on 100 parts by mass of the total amount of the unsaturated polyester resin (B) and the ethylenically unsaturated monomer (C). The content of the unsaturated polyester resin (B) in the thermosetting resin composition is preferably 80 parts by mass or less, more preferably 70 parts by mass or less, and still more preferably 60 parts by mass or less, based on 100 parts by mass of the total amount of the unsaturated polyester resin (B) and the ethylenically unsaturated monomer (C). When the content of the unsaturated polyester resin (B) in the thermosetting resin composition is 20 parts by mass or more, the cured product exhibits good mechanical strength. When the content of the unsaturated polyester resin (B) in the thermosetting resin composition is 80 parts by mass or less, the viscosity of the thermosetting resin composition can be adjusted to an appropriate range, resulting in good moldability.

### <Unsaturated Polyester Resin (B-1)>

The unsaturated polyester resin (B-1), which is a polycondensate of a mixture containing a diol and an unsaturated polybasic acid, has a structure derived from propylene glycol and a structure derived from neopentyl glycol. The unsaturated polyester resin (B-1) may have a structure derived from a saturated polybasic acid. The unsaturated polyester resin (B-1) may have a structure derived from a diol other than propylene glycol and neopentyl glycol.

The unsaturated polyester resin (B-1) may be used singly or in combination of two or more thereof. By using the unsaturated polyester resin (B-1), a cured product having excellent mechanical strength and heat resistance can be obtained.

Examples of the diols other than propylene glycol and neopentyl glycol include alkylene glycols, such as ethylene glycol, propylene glycol, butanediol, pentanediol, hexanediol, 2-methyl-1,3-propanediol, 1,4-cyclohexanedimethanol, and hydrogenated bisphenol A; polyoxyalkylene glycols, such as diethylene glycol, dipropylene glycol, triethylene glycol, tetraethylene glycol, and polyethylene glycol; bisphenol A; and alkylene oxide-modified bisphenol A, such as an ethylene oxide adduct of bisphenol A and a propylene oxide adduct of bisphenol A. From the viewpoint of crack resistance during molding, the other diol is preferably an alkylene glycol, more preferably an alkylene glycol having 2 to 6 carbon atoms, and still more preferably at least one selected from ethylene glycol, butanediol, pentanediol, and hexanediol. From the viewpoint of chemical resistance, hydrogenated bisphenol A is preferred. The other diols may be used singly or in combination of two or more thereof.

The content ratio (molar ratio) of the structure derived from propylene glycol to the structure derived from neopentyl glycol in the unsaturated polyester resin (B-1) is preferably from 10:90 to 90:10, more preferably from 15:85 to 85:15, and still more preferably from 20:80 to 80:20.

In the diol-derived structure of the unsaturated polyester resin (B-1), the propylene glycol-derived structure preferably accounts for 10 mol % or more, more preferably 20 mol % or more, and still more preferably 30 mol % or more. In the diol-derived structure of the unsaturated polyester resin (B-1), the propylene glycol-derived structure preferably accounts for 90 mol % or less, more preferably 85 mol % or less, and still more preferably 80 mol % or less.

In the diol-derived structure of the unsaturated polyester resin (B-1), the neopentyl glycol-derived structure preferably accounts for 10 mol % or more, more preferably 15 mol % or more, and still more preferably 20 mol % or more. In the diol-derived structure of the unsaturated polyester resin (B-1), the neopentyl glycol-derived structure preferably accounts for 90 mol % or less, more preferably 80 mol % or less, and still more preferably 70 mol % or less.

In the diol-derived structure of the unsaturated polyester resin (B-1), the total proportion of the propylene glycol-derived structure and the neopentyl glycol-derived structure is preferably 70 mol % or more, more preferably 75 mol % or more, and still more preferably 80 mol % or more. In the diol-derived structure of the unsaturated polyester resin (B-1), the total proportion of the propylene glycol-derived structure and the neopentyl glycol-derived structure may be 100 mol % or less, 95 mol % or less, or 90 mol % or less.

In the diol-derived structure of the unsaturated polyester resin (B-1), the other diol-derived structure preferably accounts for 0 mol % or more, more preferably 5 mol % or more, and still more preferably 10 mol % or more. In the diol-derived structure of the unsaturated polyester resin (B-1), the other diol-derived structure preferably accounts for 30 mol % or less, more preferably 25 mol % or less, and still more preferably 20 mol % or less.

The unsaturated polyester resin (B-1) may have a structure derived from a polyhydric alcohol having three or more hydroxy groups. Examples of the polyhydric alcohol having three or more hydroxy groups include glycerin. In a structure derived from a polyhydric alcohol having two or more hydroxy groups of the unsaturated polyester resin (B-1), the structure derived from a diol preferably accounts for 95 mol % or more, more preferably 98 mol % or more, and still more preferably 100 mol %. In the structure derived from a polyhydric alcohol having two or more hydroxy groups of the unsaturated polyester resin (B-1), the upper limit of the structure derived from a diol may be 100 mol % or 99 mol %.

The unsaturated polybasic acid is not particularly limited if it is a compound having an ethylenically unsaturated bond and two or more carboxy groups, or an acid anhydride thereof, and a known unsaturated polybasic acid can be used. An unsaturated polybasic acid having 4 to 6 carbon atoms or an acid anhydride thereof is preferred since a thermosetting resin composition that is lower in cost and exhibits superior mechanical strength and heat resistance of the cured product can be obtained. The unsaturated polybasic acid is preferably an unsaturated dibasic acid. Examples of the unsaturated polybasic acid include maleic acid, maleic anhydride, fumaric acid, citraconic acid, itaconic acid, and chloromaleic acid. The unsaturated polybasic acid is more preferably at least one selected from fumaric acid, maleic acid, maleic anhydride, and itaconic acid, and still more preferably at least one selected from fumaric acid and maleic anhydride. The unsaturated polybasic acid may be used singly or in combination of two or more thereof.

The saturated polybasic acid is not particularly limited if it is a compound lacking an ethylenically unsaturated bond and having two or more carboxy groups, or an acid anhydride thereof, and a known saturated polybasic acid can be used. Examples of the saturated polybasic acid include aromatic saturated polybasic acids or acid anhydrides thereof, such as phthalic acid, phthalic anhydride, isophthalic acid, terephthalic acid, tetrachlorophthalic anhydride, tetrabromophthalic anhydride, nitrophthalic acid, and halogenated phthalic anhydride; aliphatic saturated polybasic acids, such as succinic acid, adipic acid, sebacic acid, oxalic acid, malonic acid, azelaic acid, and glutaric acid; and acid anhydrides of saturated alicyclic polybasic acids, such as hexahydrophthalic anhydride. The saturated polybasic acid may be used singly or in combination of two or more thereof.

The weight-average molecular weight of the unsaturated polyester resin (B-1) is not particularly limited. The weight-average molecular weight of the unsaturated polyester resin (B-1) is preferably 2,000 or more, more preferably 5,000 or more, still more preferably 10,000 or more, and particularly preferably 13,000 or more. The weight-average molecular weight of the unsaturated polyester resin (B-1) is preferably 50,000 or less, and more preferably 35,000 or less. The weight-average molecular weight of the unsaturated polyester resin (B-1) is preferably from 2,000 to 50,000, more preferably from 5,000 to 50,000, still more preferably from 10,000 to 50,000, and particularly preferably from 13,000 to 35,000. When the weight-average molecular weight is from 2,000 to 50,000, the thermosetting resin composition exhibits further improved moldability. When the weight-average molecular weight is from 2,000 to 50,000, the occurrence of cracks during molding is further reduced. Without being bound by any theory, it is considered that setting the weight-average molecular weight of the unsaturated polyester resin (B-1) within the above range improves the compatibility with the saturated polyester resin (A) and the dispersibility of components (C) to (F), thereby further reducing the occurrence of cracks during molding.

The degree of unsaturation of the unsaturated polyester resin (B-1) is preferably from 50 mol % to 100 mol %, more preferably from 60 mol % to 100 mol %, and still more preferably from 70 mol % to 100 mol %. When the degree of unsaturation is in the above range, the thermosetting resin composition containing the unsaturated polyester resin (B-1) exhibits improved moldability.

The degree of unsaturation of the unsaturated polyester resin can be calculated by the following equation using the number of moles of the unsaturated polybasic acid and the saturated polybasic acid used as raw materials.

Degree of unsaturation (mol %)={(number of moles of unsaturated polybasic acid×number of ethylenically unsaturated bonds per molecule of unsaturated polybasic acid)/(number of moles of unsaturated polybasic acid+number of moles of saturated polybasic acid)}×100

### <Unsaturated Polyester Resin (B-2)>

The unsaturated polyester resin (B-2), which is a polycondensate of a mixture containing a diol and an unsaturated polybasic acid, has a structure derived from propylene glycol but does not have a structure derived from neopentyl glycol. The unsaturated polyester resin (B-2) may have a structure derived from a saturated polybasic acid. The unsaturated polyester resin (B-2) may have a structure derived from a diol other than propylene glycol and neopentyl glycol.

The unsaturated polyester resin (B-2) may be used singly or in combination of two or more thereof. By using the unsaturated polyester resin (B-2), the shrinkage during molding can be adjusted.

Specific and preferred examples of diols other than propylene glycol and neopentyl glycol are as in the case of the unsaturated polyester resin (B-1). The other diols may be used singly or in combination of two or more thereof.

In the diol-derived structure of the unsaturated polyester resin (B-2), the propylene glycol-derived structure preferably accounts for 30 mol % or more, more preferably 50 mol % or more, and still more preferably 70 mol % or more. In the diol-derived structure of the unsaturated polyester resin (B-2), the propylene glycol-derived structure may account for 100 mol % or less, 90 mol % or less, or 80 mol % or less.

In the diol-derived structure of the unsaturated polyester resin (B-2), the other diol-derived structure may account for 0 mol % or more, 3 mol % or more, or 5 mol % or more. In the diol-derived structure of the unsaturated polyester resin (B-2), the other diol-derived structure preferably accounts for 30 mol % or less, more preferably 20 mol % or less, and still more preferably 10 mol % or less.

The unsaturated polyester resin (B-2) may have a structure derived from a polyhydric alcohol having three or more hydroxy groups. Examples of the polyhydric alcohol having three or more hydroxy groups include glycerin. In a structure derived from a polyhydric alcohol having two or more hydroxy groups of the unsaturated polyester resin (B-2), the structure derived from a diol preferably accounts for 95 mol % or more, more preferably 98 mol % or more, and still more preferably 100 mol %. In the structure derived from a polyhydric alcohol having two or more hydroxy groups of the unsaturated polyester resin (B-2), the upper limit of the structure derived from a diol may be 100 mol % or 99 mol %.

Specific and preferred examples of the unsaturated polybasic acid are as in the case of the unsaturated polyester resin (B-1). The unsaturated polybasic acid may be used singly or in combination of two or more thereof.

Specific and preferred examples of the saturated polybasic acid are as in the case of the unsaturated polyester resin (B-1). The saturated polybasic acid may be used singly or in combination of two or more thereof.

The weight-average molecular weight of the unsaturated polyester resin (B-2) is not particularly limited. The weight-average molecular weight of the unsaturated polyester resin (B-2) is preferably from 2,000 to 50,000, more preferably from 5,000 to 50,000, still more preferably from 10,000 to 50,000, and even more preferably from 13,000 to 35,000. When the weight-average molecular weight is from 2,000 to 50,000, the thermosetting resin composition exhibits further improved moldability. When the weight-average molecular weight is from 2,000 to 50,000, the occurrence of cracks during molding is further reduced. Without being bound by any theory, it is considered that setting the weight-average molecular weight of the unsaturated polyester resin (B-2) within the above range improves the compatibility with the saturated polyester resin (A) and the dispersibility of components (C) to (F), thereby further reducing the occurrence of cracks during molding.

The degree of unsaturation of the unsaturated polyester resin (B-2) is preferably from 50 mol % to 100 mol %, more preferably from 60 mol % to 100 mol %, and still more preferably from 70 mol % to 100 mol %. When the degree of unsaturation is in the above range, the thermosetting resin composition containing the unsaturated polyester resin (B-2) exhibits improved moldability.

### (Method for Synthesizing Unsaturated Polyester Resin (B))

The unsaturated polyester resin (B) can be synthesized by a known method using the above-described raw materials. Various conditions in the synthesis of the unsaturated polyester resin (B) are appropriately set depending on the raw materials used and the amounts thereof.

Generally, an esterification reaction can be conducted in a stream of an inert gas such as nitrogen gas at a temperature of 140° C. to 230° C. under pressure or reduced pressure. In the esterification reaction, an esterification catalyst can be used, if necessary. Examples of the esterification catalyst include known catalysts such as manganese acetate, dibutyltin oxide, stannous oxalate, zinc acetate, and cobalt acetate. The esterification catalyst may be used singly or in combination of two or more thereof.

In order to increase the molecular weight by improving the reaction rate, the equivalent amount of hydroxyl groups of the polyhydric alcohol is preferably in the range of 0.9 to 1.2 based on the total amount of carboxy groups of the unsaturated polybasic acid and any saturated polybasic acid.

### [Ethylenically Unsaturated Monomer (C)]

The ethylenically unsaturated monomer (C) is not particularly limited if it is a monomer having an ethylenically unsaturated bond. The ethylenically unsaturated monomer (C) may be used singly or in combination of two or more thereof.

Specific examples thereof include vinyl compounds such as styrene, vinyltoluene, t-butylstyrene, methoxy styrene, divinylbenzene, and vinylnaphthalene; (meth)acrylates such as methyl (meth)acrylate, ethyl (meth)acrylate, propyl (meth)acrylate, n-butyl (meth)acrylate, t-butyl (meth)acrylate, 2-ethylhexyl (meth)acrylate, isodecyl (meth)acrylate, lauryl (meth)acrylate, tridecyl (meth)acrylate, stearyl (meth)acrylate, cyclohexyl (meth)acrylate, furfuryl (meth)acrylate, tetrahydrofurfuryl (meth)acrylate, phenyl (meth)acrylate, benzyl (meth)acrylate, phenoxyethyl (meth)acrylate, dicyclopentenyl (meth)acrylate, dicyclopentenyloxyethyl (meth)acrylate, allyl (meth)acrylate, isobornyl (meth)acrylate, acetoacetoxyethyl (meth)acrylate, ethylene glycol di(meth)acrylate, diethylene glycol di(meth)acrylate, propylene glycol di(meth)acrylate, neopentyl glycol di(meth)acrylate, tricyclodecanol di(meth)acrylate, and trimethylolpropane tri(meth)acrylate; and cyclic unsaturated compounds such as acenaphthylene and norbornene. From the viewpoint of copolymerizability with the unsaturated polyester resin (B), vinyl compounds are preferred, one or more selected from styrene, vinyltoluene, t-butylstyrene, and methoxystyrene are more preferred, and styrene is still more preferred. The content of the ethylenically unsaturated monomer (C) in the thermosetting

resin composition is preferably 20 parts by mass or more, more preferably 30 parts by mass or more, and still more preferably 40 parts by mass or more, based on 100 parts by mass of the total amount of the unsaturated polyester resin (B) and the ethylenically unsaturated monomer (C). The content of the ethylenically unsaturated monomer (C) in the thermosetting resin composition is preferably 80 parts by mass or less, more preferably 70 parts by mass or less, and still more preferably 60 parts by mass or less, based on 100 parts by mass of the total amount of the unsaturated polyester resin (B) and the ethylenically unsaturated monomer (C). When the content of the ethylenically unsaturated monomer (C) in the thermosetting resin composition is 20 parts by mass or more, the viscosity of the thermosetting resin composition can be adjusted to an appropriate range, resulting in good moldability. When the content of the ethylenically unsaturated monomer (C) in the thermosetting resin composition is 80 parts by mass or less, the curable product exhibits good mechanical strength.

### [Thermal Polymerization Initiator (D)]

The thermal polymerization initiator is not particularly limited if it is a polymerization initiator that generates radicals upon heating. Examples thereof include organic peroxides such as diacyl peroxide, Pero yester, hydroperoxide, dialkyl peroxide, ketone peroxide, peroxyketal, alkyl perester, and percarbonate.

Among the organic peroxides, the thermal polymerization initiator (D) is preferably 1,1-di-t-hexylperoxy-cyclohexane, t-hexylperoxy isopropyl carbonate, t-butylperoxy octoate, t-butylperoxy-2-ethylhexanoate, t-hexylperoxy-2-ethylhexanoate, t-amylperoxy-2-ethylhexanoate, benzoyl peroxide, 1,1-di-t-butylperoxy-3,3,5-trimethylcyclohexane, t-butylperoxy isopropyl carbonate, t-butylperoxy benzoate, dicumyl peroxide, and di-t-butyl peroxide. The thermal polymerization initiator (D) may be used singly or in combination of two or more thereof.

The content of the thermal polymerization initiator (D) in the thermosetting resin composition is preferably 0.5 parts by mass or more, more preferably 1 part by mass or more, and still more preferably 3 parts by mass or more, based on 100 parts by mass of the total amount of the unsaturated polyester resin (B) and the ethylenically unsaturated monomer (C). The content of the thermal polymerization initiator (D) in the thermosetting resin composition is preferably 20 parts by mass or less, more preferably 15 parts by mass or less, and still more preferably 10 parts by mass or less, based on 100 parts by mass of the total amount of the unsaturated polyester resin (B) and the ethylenically unsaturated monomer (C). When the content of the thermal polymerization initiator (D) in the thermosetting resin composition is 0.5 parts by mass or more, the curing reaction of the thermosetting resin composition during molding proceeds uniformly, and the cured product exhibits good physical properties and appearance. When the content of the thermal polymerization initiator (D) in the thermosetting resin composition is 20 parts by mass or less, the storage stability of the thermosetting resin composition becomes favorable, resulting in improved handleability.

### [Glass Fiber (E)]

The glass fiber (E) is not particularly limited if it is a fibrous substance having an aspect ratio of 3 or more. Specific examples thereof include chopped strand glass.

The fiber length of the glass fiber (E) is preferably 20 mm or less, more preferably 10 or less, and still more preferably 5 mm or less. When the fiber length is 20 mm or less, the thermosetting resin composition exhibits good moldability, and the cured product exhibits good appearance. The fiber length is preferably 0.1 mm or more, more preferably 0.5 or more, and still more preferably 1 mm or more. When the fiber length is 0.1 mm or more, the strength of the cured product is good. The average fiber diameter of the glass fiber (E) is preferably from 3 μm to 100 μm and more preferably from 5 μm to 30 μm.

The content of the glass fiber (E) in the thermosetting resin composition is preferably 5 parts by mass or more, more preferably 10 parts by mass or more, and still more preferably 20 parts by mass or more, based on 100 parts by mass of the total amount of the unsaturated polyester resin (B) and the ethylenically unsaturated monomer (C). The content of the glass fiber (E) in the thermosetting resin composition is preferably 150 parts by mass or less, more preferably 100 parts by mass or less, and still more preferably 50 parts by mass or less, based on 100 parts by mass of the total amount of the unsaturated polyester resin (B) and the ethylenically unsaturated monomer (C). When the content of the glass fiber (E) in the thermosetting resin composition is 5 parts by mass or more, the cured product obtained from the thermosetting resin composition exhibits improved mechanical properties. When the content of the glass fiber (E) in the thermosetting resin composition is 150 parts by mass or less, the glass fiber (E) is more uniformly dispersed in the thermosetting resin composition, allowing the production of a homogeneous cured product.

### [Inorganic Filler (F)]

The inorganic filler (F) used may be any particulate substance known in the technical field of the present invention. The use of the inorganic filler (F) can reduce the molding shrinkage of the molded article, adjust the viscosity of the thermosetting resin composition to thereby improve workability, and enhance the strength of the molded article.

Examples of the inorganic filler (F) include calcium carbonate, silica, alumina, aluminum hydroxide, barium sulfate, calcium sulfate, calcium hydroxide, calcium oxide, magnesium oxide, magnesium hydroxide, wollastonite, clay, kaolin, mica, gypsum, silicic anhydride, and glass powder. Calcium carbonate, aluminum oxide, and aluminum hydroxide are preferred because of their low cost. The inorganic filler (F) may be used singly or in combination of two or more thereof.

The average particle size of the inorganic filler is preferably from 1 μm to 100 μm, more preferably from 1 μm to 60 μm, and still more preferably from 1 μm to 50 μm. When the average particle size of the inorganic filler (F) is 1 μm or more, aggregation of particles can be prevented. On the other hand, when the average particle size of the inorganic filler (F) is 100 μm or less, the thermosetting resin composition has good moldability.

As used herein, the term “average particle size” refers to the 50% particle size (D50) in the volume-based cumulative particle size distribution measured using a laser diffraction/scattering particle size distribution analyzer (MicrotracBEL Corp., FRA).

The shape of the inorganic filler (F) is not particularly limited. Examples thereof include a substantially true sphere, an ellipsoid, a scale-like shape, and an amorphous shape.

The content of the inorganic filler (F) in the thermosetting resin composition is preferably 50 parts by mass or more, more preferably 100 parts by mass or more, and still more preferably 200 parts by mass or more, based on 100 parts by mass of the total amount of the unsaturated polyester resin (B) and the ethylenically unsaturated monomer (C). The content of the inorganic filler (F) in the thermosetting resin composition is preferably 1000 parts by mass or less, more preferably 800 parts by mass or less, and still more preferably 500 parts by mass or less, based on 100 parts by mass of the total amount of the unsaturated polyester resin (B) and the ethylenically unsaturated monomer (C). When the content of the inorganic filler (F) in the thermosetting resin composition is 50 parts by mass or more, the cured product exhibits improved mechanical properties. When the content of the inorganic filler (F) in the thermosetting resin composition is 1000 parts by mass or less, the inorganic filler (F) is more uniformly dispersed in the thermosetting resin composition, allowing the production of a homogeneous cured product.

### [Another Low-Profile Additive (G)]

The thermosetting resin composition may include (G) a low-profile additive other than the saturated polyester resin, if necessary. The other low-profile additive (G) used is not particularly limited and may be any conventionally known agent in the technical field of the present invention. The other low-profile additive (G) is preferably a thermoplastic resin. Examples of the other low-profile additive (G) include polystyrene, polyethylene, polymethyl methacrylate, polyvinyl acetate, polycaprolactone, and styrene-butadiene rubber. Among them, polystyrene is preferred from the viewpoint of reducing the shrinkage of the cured product. The other low-profile additive (G) may be used singly or in combination of two or more thereof.

The content of the other low-profile additive (G) in the thermosetting resin composition is preferably 1 part by mass or more, more preferably 3 parts by mass or more, and still more preferably 5 parts by mass or more, based on 100 parts by mass of the total amount of the unsaturated polyester resin (B) and the ethylenically unsaturated monomer (C). The content of the other low-profile additive (G) in the thermosetting resin composition is preferably 30 parts by mass or less, more preferably 20 parts by mass or less, and still more preferably 10 parts by mass or less, based on 100 parts by mass of the total amount of the unsaturated polyester resin (B) and the ethylenically unsaturated monomer (C). When the content of the other low-profile additive (G) in the thermosetting resin composition is 1 part by mass or more, the cured product exhibits reduced shrinkage, allowing the molded article to attain the desired dimensional accuracy. When the content of the other low-profile additive (G) in the thermosetting resin composition is 30 parts by mass or less, the moldability of the thermosetting resin composition and the mechanical properties of the cured product are further improved.

### [Mold Release Agent (H)]

The thermosetting resin composition may contain a mold release agent (H), if necessary. The mold release agent (H) used is not particularly limited and may be any conventionally known agent in the technical field of the present invention. Examples of the mold release agent (H) include stearic acid, oleic acid, zinc stearate, calcium stearate, aluminum stearate, magnesium stearate, streamside, oleamide, silicone oil, and synthetic wax. The mold release agent (H) may be used singly or in combination of two or more thereof.

The content of the mold release agent (H) when used is preferably from 1 part by mass to 40 parts by mass, more preferably from 5 parts by mass to 30 parts by mass, and still more preferably from 8 parts by mass to 20 parts by mass based on 100 parts by mass of the unsaturated polyester resin (B). When the content of the mold release agent (H) is 1 part by mass or more, the cured product has good mold releasability upon mold shaping, resulting in good product productivity. On the other hand, when the content of the mold release agent (H) is 40 parts by mass or less, the surface of the cured product is not contaminated by the excessive mold release agent, and a cured product having good appearance can be obtained.

### [Other Additive]

In addition to the above-described components, the thermosetting resin composition may contain components known in the technical field of the present invention, such as a viscosity modifier including a thickener or a viscosity reducer, a colorant, a polymerization inhibitor, and a molding aid, within a range where the effects of the present invention are not impaired.

The thickener is a compound other than the inorganic filler (F) exhibiting a thickening effect, and examples thereof include isocyanate compounds. The thickener may be used singly or in combination of two or more thereof. The content of the thickener can be appropriately adjusted depending on the required handleability, fluidity, and the like of the thermosetting resin composition.

The colorant is used, for example, when coloring the cured product. Examples of the colorant include various dyes, inorganic pigments, and organic pigments. The colorant may be used singly or in combination of two or more thereof. The content of the colorant can be appropriately adjusted depending on the degree of coloration desired in the cured product.

Examples of the polymerization inhibitor include hydroquinone, trimethylhydroquinone, p-benzoquinone, naphthoquinone, t-butylhydroquinone, catechol, p-t-butylcatechol, and 2,6-di-t-butyl-4-methylphenol. The polymerization inhibitor may be used singly or in combination of two or more thereof. The content of the polymerization inhibitor can be appropriately adjusted depending on the storage environment, storage period, curing conditions, and the like of the thermosetting resin composition.

### <Method for Producing Thermosetting Resin Composition>

The thermosetting resin composition may be produced by mixing a saturated polyester resin (A), an unsaturated polyester resin (B), an ethylenically unsaturated monomer (C), a thermal polymerization initiator (D), a glass fiber (E), and an inorganic filler (F), together with, if necessary, optional components such as another low-profile additive (G), a mold release agent (H), and other additives.

Examples of the mixing method include kneading. The kneading method is not particularly limited, and for example, a kneader, a disperser, or a planetary mixer can be used. The kneading temperature is preferably from 5° C. to 50° C., and more preferably from 10° C. to 40° C.

The order of mixing the respective components in the production of the thermosetting resin composition is not particularly limited. For example, mixing the unsaturated polyester resin (B) with a part or all the ethylenically unsaturated monomer (C) and then with another component is preferred because a thermosetting resin composition in which the respective components are sufficiently dispersed or uniformly mixed is easily obtained. At least a part of the ethylenically unsaturated monomer (C) may be premixed with the unsaturated polyester resin (B) to act as a solvent, a dispersion medium or the like.

### <Method for Producing Molding Material>

The molding material can be produced by heating and curing the thermosetting resin composition. Conditions for curing the thermosetting resin composition can be appropriately set depending on the material used, the decomposition temperature of the thermal polymerization initiator (D), and the like. One example of preferred conditions is a temperature of 120° C. to 180° C., more preferably a temperature of 120° C. to 160° C. and a curing time of 1 minute to 30 minutes.

### <Method for Producing Molded Stator>

The molded stator can be produced, for example, by injecting the thermosetting resin composition into a mold in which the stator is disposed at a predetermined position, followed by heating. The molding method is not particularly limited, and examples of methods usually performed in the technical field of the present invention include transfer molding and injection molding.

More specific examples of the method for producing a molded stator include a method of opening a mold to pour a thermosetting resin composition into the mold in which a stator is installed, followed by curing; and a method of injecting a thermosetting resin composition from the outside into a closed mold in which a stator is installed, through a hole provided in the mold such as a sprue, under reduced pressure in the mold or in a state where pressure is applied from the outside of the mold as represented by injection molding, followed by curing. Conditions for curing the thermosetting resin composition in the mold can be appropriately set depending on the material used. One example of preferred conditions is a temperature of 120° C. to 180, more preferably a temperature of 120° C. to 160° C. and a curing time of 1 minute to 30 minutes.

### EXAMPLES

Hereinafter, the present invention will be described in more detail with reference to Examples and Comparative Examples, but the present invention is not limited to Examples below.

Synthesis examples of the saturated polyester resin (A) are shown below.

The following raw materials were used.
Diol
Diethylene glycol (FUJIFILM Wako Pure Chemical Corporation)
Dipropylene glycol (FUJIFILM Wako Pure Chemical Corporation)
Saturated polybasic acid:
Isophthalic acid (FUJIFILM Wako Pure Chemical Corporation)
Adipic acid (FUJIFILM Wako Pure Chemical Corporation)

### Synthesis Example 1

In a four-neck flask equipped with a thermometer, a stirrer, an inert gas inlet, and a reflux condenser, 50 parts by mole of isophthalic acid, 60 parts by mole of diethylene glycol, and 40 parts by mole of dipropylene glycol were charged. Under a nitrogen gas stream, the mixture was heated with stirring to 210° C. to perform an esterification reaction. When the acid value of the reaction solution reached 10 KOH mg/g or less, 50 parts by mole of adipic acid were further added, and the esterification reaction was continued to obtain a saturated polyester resin. Thereafter, when the acid value of the reaction solution reached 10 KOH mg/g or less, styrene monomer was added in an amount of 40% by mass based on the total of the saturated polyester resin and the styrene monomer to obtain a mixture of the saturated polyester resin and styrene. The obtained saturated polyester resin had a weight-average molecular weight (Mw) of 10,000. The obtained block (X) of the saturated polyester resin had a weight-average molecular weight (Mw) of 4,000.

TABLE 1
(Composition in Parts by Mole)

| | | | Synthesis | Synthesis | Synthesis | Synthesis | Synthesis |
|---|---|---|---|---|---|---|---|
| | | | Example 1 | Example 2 | Example 3 | Example 4 | Example 5 |
| Composition | Diol | Diethylene glycol | 60 | 60 | 60 | 55 | 65 |
| | | Dipropylene glycol | 40 | 40 | 40 | 45 | 35 |
| | Saturated | Isophthalic acid | 50 | 50 | 50 | 50 | 50 |
| | polybasic | Adipic acid | 50 | 50 | 50 | 50 | 50 |
| | acid | | | | | | |

| | | | | | |
|---|---|---|---|---|---|
| Weight-average molecular weight | 4000 | 4000 | 4000 | 4000 | 4000 |
| (Mw) of block (X) | | | | | |
| Weight-average molecular weight | 10000 | 11000 | 12500 | 10000 | 10000 |
| (Mw) of saturated polyester resin | | | | | |

### Synthesis Examples 2 to 5

A mixture of the saturated polyester resin and styrene was obtained in the same manner as in Synthesis Example 1, except that the composition in Table 1 was used. The weight-average molecular weight (Mw) of the saturated polyester resin and the weight-average molecular weight (Mw) of the block (X) of the saturated polyester resin are listed in Table 1.

Synthesis examples of the unsaturated polyester resin (B) are shown below.

The following raw materials were used.
Diol:
Propylene glycol (FUJIFILM Wako Pure Chemical Corporation)
Neopentyl glycol (FUJIFILM Wako Pure Chemical Corporation)
Hydrogenated bisphenol A (FUJIFILM Wako Chemical Corporation)
Unsaturated polybasic acid:
Maleic anhydride (FUJIFILM Wako Pure Chemical Corporation)
Fumaric acid (FUJIFILM Wako Pure Chemical Corporation)
Saturated polybasic acid:
Isophthalic acid (FUJIFILM Wako Pure Chemical Corporation)

### [Synthesis Example 6] Synthesis of Unsaturated Polyester Resin (B-1)

In a four-neck flask equipped with a thermometer, a stirrer, an inert gas inlet, and a reflux condenser, 100 parts by mole of maleic anhydride, 60 parts by mole of propylene glycol, and 40 parts by mole of neopentyl glycol were charged. Under a nitrogen gas stream, the mixture was heated with stirring to 210° C. to perform an esterification reaction, thereby obtaining an unsaturated polyester resin. Subsequently, a styrene monomer was added in an amount of 40% by mass based on the total of the unsaturated polyester resin and the styrene monomer to obtain a mixture of the unsaturated polyester resin and styrene. The obtained unsaturated polyester resin had a degree of unsaturation of 100 mol % and a weight-average molecular weight (Mw) of 20,000.

TABLE 2
(Composition in Parts by Mole)

| | | | Synthesis | Synthesis | Synthesis | Synthesis | Synthesis | Synthesis |
|---|---|---|---|---|---|---|---|---|
| | | | Example | Example | Example | Example | Example | Example |
| | | | 6 | 7 | 8 | 9 | 10 | 11 |
| Composition | Diol | Propylene glycol | 60 | 50 | 30 | 100 | 100 | 70 |
| | | Neopentyl glycol | 40 | 30 | 70 | — | — | — |
| | | Hydrogenated | — | 20 | — | — | — | 30 |
| | | bisphenol A | | | | | | |
| | Unsaturated | Maleic anhydride | 100 | 100 | 80 | — | 90 | 100 |
| | polybasic acid | Fumaric acid | — | — | — | 100 | — | — |
| | Saturated | Isophthalic acid | — | — | 20 | — | 10 | — |
| | polybasic acid | | | | | | | |

| | | | | | | |
|---|---|---|---|---|---|---|
| Weight-average molecular weight | 20000 | 15000 | 30000 | 15000 | 15000 | 10000 |
| (Mw) | | | | | | |

### [Synthesis Examples 7 and 8] Synthesis of Unsaturated Polyester Resin (B-1)

A mixture of the unsaturated polyester resin and styrene was obtained in the same manner as in Synthesis Example 6, except that the composition in Table 2 was used. The weight-average molecular weight (Mw) of the unsaturated polyester resin is listed in Table 2.

### [Synthesis Examples 9 to 11] Synthesis of Unsaturated Polyester Resin (B-2)

A mixture of the unsaturated polyester resin and styrene was obtained in the same manner as in Synthesis Example 6, except that the composition in Table 2 was used. The weight-average molecular weight (Mw) of the unsaturated polyester resin is listed in Table 2.

The other components used were as follows.

Ethylenically unsaturated monomer (C):
Styrene (Idemitsu Kosan Co., Ltd.)

Thermal polymerization initiator (D):
PERHEXYL (TM) I (t-hexylperoxy isopropyl carbonate, NOF Corporation)

Glass fiber (E):
Chopped strand ECS-03B173/P9 (glass chopped, fiber diameter: 13 μm, fiber length: 3.0 mm, Nippon Electric Glass Co., Ltd.)

Inorganic filler (F):
Softon 1200 (calcium carbonate, average particle size: 1.80 μm, Bihoku Funka Kogyo Co., Ltd.)
Calcium hydroxide (Kishida Chemical Co., Ltd.)

Another low-profile additive (G)
PS MS-200 (polystyrene, Sekisui Kasei Co., Ltd.)

### Example 1

### (Preparation of Thermosetting Resin Composition)

A thermosetting resin composition was prepared by charging 27 parts by mass of a mixture of the saturated polyester resin obtained in Synthesis Example 1 and styrene (16 parts by mass of the saturated polyester resin and 11 parts by mass of styrene) as the saturated polyester resin (A) and the ethylenically unsaturated monomer (C), 85 parts by mass of a mixture of the unsaturated polyester resin obtained in Synthesis Example 6 and styrene (51 parts by mass of the unsaturated polyester resin and 34 parts by mass of styrene) as the unsaturated polyester resin (B) and the ethylenically unsaturated monomer (C), an additional 4 parts by mass of styrene as the ethylenically unsaturated monomer (C), 4 parts by mass of PERHEXYL (TM) I as the thermal polymerization initiator (D), 36 parts by mass of chopped strand ECS-03B173/P9 as the glass fiber (E), 390 parts by mass of Softon 1200 and 0.4 parts by mass of calcium hydroxide as the inorganic fillers (F), and 6 parts by mass of polystyrene as another low-profile additive (G) into a twin-arm kneader, followed by kneading at 30° C. for 30 minutes.

### (Viscosity)

The viscosity of the thermosetting resin composition immediately after kneading was evaluated using a flow tester. Specifically, the flow tester viscosity (Pas) of the thermosetting resin composition was measured using a flow tester viscometer (measuring instrument: CFT-500D, manufactured in 2011 by Shimadzu Corporation) under conditions of a die of q 1.5 mm×10 mm, a heating temperature of 70° C., and a load of 7 MPa. The results are shown in Table 3.

### (Molding Shrinkage at Initial Stage)

In accordance with JIS K-6911 (2006), 5.7, a disk-shaped test piece (q 90 mm×11 mm) was obtained by compression molding under the conditions of a molding temperature of 120° C., a molding pressure of 5 MPa, and a molding time of 3 minutes using a compression molding machine (Techno Marushichi Co., Ltd.) to calculate the molding shrinkage. The test piece was prepared using a thermosetting resin composition immediately after kneading. The results are shown in Table 3.

(Molding Shrinkage after Aging)

In accordance with JIS K-6911 (2006), 5.7, a disk-shaped test piece (q 90 mm×11 mm) was obtained by compression molding under the conditions of a molding temperature of 120° C., a molding pressure of 5 MPa, and a molding time of 3 minutes using a compression molding machine (Techno Marushichi Co., Ltd.) to calculate the molding shrinkage. The test piece was prepared using a thermosetting resin composition that had been kneaded and then stored in an environment of 20° C. for 30 days. The results are shown in Table 3.

### (Preparation of Molded Stator)

The stator was disposed in the mold, and the thermosetting resin composition was injected and molded at a molding temperature of 130° C., a molding pressure of 5 MPa, and a molding time of 5 minutes to obtain a molded stator. The filling property during molding and the appearance of the molded stator from the viewpoint of cracks were evaluated according to the following criteria. The results are shown in Table 3.

### <<Filling Property During Molding of Molded Stator at Initial Stage>>

The appearance of the molded stator prepared using a thermosetting resin composition immediately after kneading was visually observed, and a state where a cured product of the thermosetting resin composition was completely filled without any defect along the mold shape was evaluated as good, while a state with a partial defect was evaluated as poor.

<<Filling Property During Molding of Molded Stator after Aging>>

The appearance of the molded stator prepared using a thermosetting resin composition that had been kneaded and then stored in an environment of 20° C. for 30 days was visually observed, and a state where a cured product of the thermosetting resin composition was completely filled without any defect along the mold shape was evaluated as good, and a state with a partial defect was evaluated as poor.

<<Appearance of Molded Stator from Viewpoint of Crack at Initial Stage>>

The appearance of the molded stator prepared using a thermosetting resin composition immediately after kneading was visually observed, and a molded stator without the occurrence of cracks was evaluated as good, while a molded stator with the occurrence of cracks was evaluated as poor.

<<Appearance of Molded Stator from Viewpoint of Crack after Aging>>

The appearance of the molded stator prepared using a thermosetting resin composition that had been kneaded and then stored in an environment of 20° C. for 30 days was visually observed, and a molded stator without the occurrence of cracks was evaluated as good, while a molded stator with the occurrence of cracks was evaluated as poor.

### (Thermal Cycling Test)

Using a thermal cycling tester (tester: TSA-71L-A, manufactured in 2010, ESPEC Corp.), a thermal cycling test was conducted in air at −40° C. for 20 minutes and 140° C. for 20 minutes for a molded stator prepared using a thermosetting resin composition that had been kneaded and then stored in an environment of 20° C. for 30 days. The test was conducted for 250 cycles, and the appearance of the molded stator was visually observed every 50 cycles to check for the occurrence of cracks. The maximum number of cycles without the occurrence of cracks is shown in Table 3.

TABLE 3
(Composition in Parts by Mass)

| | | | | Exam- | Exam- | Exam- | Exam- | Exam- | Exam- | Exam- | Exam- |
|---|---|---|---|---|---|---|---|---|---|---|---|
| | | | Mw | ple 1 | ple 2 | ple 3 | ple 4 | ple 5 | ple 6 | ple 7 | ple 8 |
| Composition | Saturated | Synthesis Example 1 | 10000 | — | — | — | 16 | — | — | — | — |
| | polyester resin | Synthesis Example 2 | 11000 | 16 | 16 | 16 | — | — | 16 | 16 | — |
| | (A) | Synthesis Example 3 | 12500 | — | — | — | — | 16 | — | | — |
| | | Synthesis Example 4 | 10000 | — | — | — | — | — | — | — | 16 |
| | | Synthesis Example 5 | 10000 | — | — | — | — | — | — | — | — |
| | Unsaturated | Synthesis Example 6 | 20000 | 51 | 26 | 26 | 51 | 51 | — | — | 51 |
| | polyester resin | Synthesis Example 7 | 15000 | — | — | — | — | — | 51 | — | — |
| | (B-1) | Synthesis Example 8 | 30000 | — | — | — | — | — | — | 51 | — |
| | Unsaturated | Synthesis Example 9 | 15000 | — | 25 | — | — | — | — | — | — |
| | polyester resin | Synthesis Example 10 | 15000 | — | | 25 | — | — | — | — | — |
| | (B-2) | Synthesis Example 11 | 10000 | — | | | — | — | — | — | — |
| | Ethylenically | Styrene | | 49 | 49 | 49 | 49 | 49 | 49 | 49 | 49 |
| | unsaturated | | | | | | | | | | |
| | monomer (C) | | | | | | | | | | |
| | Thermal | PerhexyI I | | 4 | 4 | 4 | 4 | 4 | 4 | 4 | 4 |
| | polymerization | | | | | | | | | | |
| | initiator (D) | | | | | | | | | | |
| | Glass fiber (E) | Chopped strand | | 36 | 36 | 36 | 36 | 36 | 36 | 36 | 36 |
| | Inorganic filler | Calcium carbonate | | 390 | 390 | 390 | 390 | 390 | 390 | 390 | 390 |
| | (F) | Calcium hydroxide | | 0.4 | 0.4 | 0.4 | 0.4 | 0.4 | 0.4 | 0.4 | 0.4 |
| | Another low- | Polystyrene | | 6 | 6 | 6 | 6 | 6 | 6 | 6 | 6 |
| | profile additive | | | | | | | | | | |
| | (G) | | | | | | | | | | |

| | | | | | | | | |
|---|---|---|---|---|---|---|---|---|
| Flow tester viscosity [Pa · s] | 60 | 60 | 60 | 60 | 60 | 60 | 60 | 60 |
| Molding shrinkage at initial stage [%] | −0.04 | −0.06 | −0.06 | −0.02 | −0.02 | −0.02 | −0.02 | −0.01 |
| Molding shrinkage after aging [%] | −0.02 | −0.05 | −0.02 | −0.01 | −0.01 | −0.01 | −0.01 | 0.00 |
| Filling property during molding of | Good | Good | Good | Good | Good | Good | Good | Good |
| molded stator at initial stage | | | | | | | | |
| Filling property during molding of | Good | Good | Good | Good | Good | Good | Good | Good |
| molded stator after aging | | | | | | | | |
| Appearance of molded stator from | Good | Good | Good | Good | Good | Good | Good | Good |
| viewpoint of crack at initial stage | | | | | | | | |
| Appearance of molded stator from | Good | Good | Good | Good | Good | Good | Good | Good |
| viewpoint of crack after aging | | | | | | | | |
| Thermal cycling test | 250 | 250 | 250 | 250 | 250 | 250 | 250 | 200 |

| | | | | | Compar- | Compar- | Compar- |
|---|---|---|---|---|---|---|---|
| | | | | Exam- | ative | ative | ative |
| | | | Mw | ple 9 | Example 1 | Example 2 | Example 3 |
| Composition | Saturated | Synthesis Example 1 | 10000 | — | — | — | — |
| | polyester resin | Synthesis Example 2 | 11000 | — | 16 | 16 | 16 |
| | (A) | Synthesis Example 3 | 12500 | — | — | — | — |
| | | Synthesis Example 4 | 10000 | — | — | — | — |
| | | Synthesis Example 5 | 10000 | 16 | — | — | — |
| | Unsaturated | Synthesis Example 6 | 20000 | 51 | — | — | — |
| | polyester resin | Synthesis Example 7 | 15000 | — | — | — | — |
| | (B-1) | Synthesis Example 8 | 30000 | — | — | — | — |
| | Unsaturated | Synthesis Example 9 | 15000 | — | 51 | — | — |
| | polyester resin | Synthesis Example 10 | 15000 | — | — | 51 | — |
| | (B-2) | Synthesis Example 11 | 10000 | — | — | — | 51 |

| Ethylenically | Styrene | 49 | 49 | 49 | 49 |
|---|---|---|---|---|---|
| unsaturated | | | | | |
| monomer (C) | | | | | |
| Thermal | PerhexyI I | 4 | 4 | 4 | 4 |
| polymerization | | | | | |
| initiator (D) | | | | | |
| Glass fiber (E) | Chopped strand | 36 | 36 | 36 | 36 |
| Inorganic filler | Calcium carbonate | 390 | 390 | 390 | 390 |
| (F) | Calcium hydroxide | 0.4 | 0.4 | 0.4 | 0.4 |
| Another low- | Polystyrene | 6 | 6 | 6 | 6 |
| profile additive | | | | | |
| (G) | | | | | |

| | | | | |
|---|---|---|---|---|
| Flow tester viscosity [Pa · s] | 60 | 60 | 60 | 60 |
| Molding shrinkage at initial stage [%] | −0.01 | −0.05 | −0.05 | 0.05 |
| Molding shrinkage after aging [%] | 0.00 | 0.04 | 0.04 | 0.07 |
| Filling property during molding of | Good | Good | Good | Good |
| molded stator at initial stage | | | | |
| Filling property during molding of | Good | Good | Good | Good |
| molded stator after aging | | | | |
| Appearance of molded stator from | Good | Good | Good | Poor |
| viewpoint of crack at initial stage | | | | |
| Appearance of molded stator from | Good | Poor | Poor | Poor |
| viewpoint of crack after aging | | | | |
| Thermal cycling test | 200 | — | — | — |

### Examples 2 to 9 and Comparative Examples 1 to 3

A thermosetting resin composition was prepared in the same manner as in Example 1, except that the composition of the raw materials was changed as listed in Table 3. Then, various evaluations were performed in the same manner as in Example 1. The results are shown in Table 3. Note that the thermal cycling test was not conducted for Comparative Examples 1 to 3.

### REFERENCE SIGNS LIST

10 motor
11 stator
12 stator core
13 coil
14 molding material
15 rotor
16 magnet
17 rotary shaft
18 rotation body
19 bearing

1. A molded stator comprising:
a stator including a stator core and a coil wound on the stator core; and
a molding material covering the stator,
wherein the molding material is a cured product of a thermosetting resin composition containing a saturated polyester resin (A), an unsaturated polyester resin (B), an ethylenically unsaturated monomer (C), a thermal polymerization initiator (D), a glass fiber (E), and an inorganic filler (F), wherein:
the unsaturated polyester resin (B) includes at least a first unsaturated polyester resin (B-1);
the first unsaturated polyester resin (B-1) is a polycondensate of a mixture including a diol and an unsaturated polybasic acid; and
the first unsaturated polyester resin (B-1) has a structure derived from propylene glycol and a structure derived from neopentyl glycol.

2. The molded stator according to claim 1, wherein a content ratio (molar ratio) of the structure derived from propylene glycol to the structure derived from neopentyl glycol in the first unsaturated polyester resin (B-1) is from 10:90 to 90:10.

3. The molded stator according to claim 1, wherein the first unsaturated polyester resin (B-1) further has a structure derived from hydrogenated bisphenol A.

4. The molded stator according to claim 1, wherein:
the unsaturated polyester resin (B) further includes a second unsaturated polyester resin (B-2);
the second unsaturated polyester resin (B-2) is a polycondensate of a mixture including a diol and an unsaturated polybasic acid; and
the second unsaturated polyester resin (B-2) has a structure derived from propylene glycol but does not have a structure derived from neopentyl glycol.

5. The molded stator according to claim 1, wherein the first unsaturated polyester resin (B-1) has a structure derived from a saturated polybasic acid.

6. The molded stator according to claim 4, wherein the second unsaturated polyester resin (B-2) has a structure derived from a saturated polybasic acid.

7. The molded stator according to claim 1, wherein the first unsaturated polyester resin (B-1) has a weight-average molecular weight of 10000 to 50000.

8. The molded stator according to claim 1, wherein:
the saturated polyester resin (A) is a polycondensate of a mixture containing a diol and a saturated polybasic acid; and
the saturated polybasic acid includes an aromatic saturated polybasic acid or an acid anhydride thereof, and an aliphatic saturated polybasic acid.

9. The molded stator according to claim 8, wherein:
in the saturated polyester resin (A), a content ratio (molar ratio) of a structure derived from the aromatic saturated polybasic acid or an acid anhydride thereof to a structure derived from the aliphatic saturated polybasic acid is from 20:80 to 80:20; and
the saturated polyester resin (A) includes a first block (X) that is a polycondensate of a diol and the aromatic saturated polybasic acid or an acid anhydride thereof; and a second block (Y) that is a polycondensate of a diol and the aliphatic saturated polybasic acid, the first block (X) having a weight-average molecular weight of 3000 to 5000.

10. The molded stator according to claim 9, wherein the aromatic saturated polybasic acid constituting the first block (X) is at least one selected from isophthalic acid and terephthalic acid.

11. The molded stator according to claim 9, wherein the aliphatic saturated polybasic acid constituting the second block (Y) is at least one selected from succinic acid, adipic acid, and sebacic acid.

12. The molded stator according to claim 1, wherein the saturated polyester resin (A) has a weight-average molecular weight of 9500 to 13500.

13. The molded stator according to claim 1, wherein the thermosetting resin composition includes, based on a total amount of 100 parts by mass of the unsaturated polyester resin (B) and the ethylenically unsaturated monomer (C):
the saturated polyester resin (A) in an amount of 5 parts by mass to 30 parts by mass;
the unsaturated polyester resin (B) in an amount of 20 parts by mass to 80 parts by mass;
the ethylenically unsaturated monomer (C) in an amount of 80 parts by mass to 20 parts by mass;
the thermal polymerization initiator (D) in an amount of 0.5 parts by mass to 20 parts by mass;
the glass fiber (E) in an amount of 5 parts by mass to 150 parts by mass; and
the inorganic filler (F) in an amount of 50 parts by mass to 1000 parts by mass.

14. A motor comprising:
the molded stator according to claim 1;
a rotor disposed inside the stator, the rotor including a rotary shaft configured to extend in a shaft center direction and a rotation body configured to contain a magnet component, to extend in the shaft center direction, and to be fixed to the rotary shaft; and
a bearing configured to rotatably support the rotor.

15. A thermosetting resin composition comprising:
a saturated polyester resin (A);
an unsaturated polyester resin (B);
an ethylenically unsaturated monomer (C);
a thermal polymerization initiator (D);
a glass fiber (E); and
an inorganic filler (F), wherein:
the unsaturated polyester resin (B) includes at least a first unsaturated polyester resin (B-1);
the first unsaturated polyester resin (B-1) is a polycondensate of a mixture including a diol and an unsaturated polybasic acid; and
the first unsaturated polyester resin (B-1) has a structure derived from propylene glycol and a structure derived from neopentyl glycol.

16. The thermosetting resin composition according to claim 15, wherein the first unsaturated polyester resin (B-1) further has a structure derived from hydrogenated bisphenol A.

17. The thermosetting resin composition according to claim 15, wherein:
the saturated polyester resin (A) is a polycondensate of a mixture including a diol and a saturated polybasic acid;
the saturated polybasic acid includes an aromatic saturated polybasic acid or an acid anhydride thereof, and an aliphatic saturated polybasic acid;
in the saturated polyester resin (A), a content ratio (molar ratio) of a structure derived from the aromatic saturated polybasic acid or an acid anhydride thereof to a structure derived from the aliphatic saturated polybasic acid is from 20:80 to 80:20; and
the saturated polyester resin (A) includes a first block (X) that is a polycondensate of a diol and the aromatic saturated polybasic acid or an acid anhydride thereof; and a second block (Y) that is a polycondensate of a diol and the aliphatic saturated polybasic acid, the first block (X) having a weight-average molecular weight of 3000 to 5000.

18. The thermosetting resin composition according to claim 15, comprising, based on a total amount of 100 parts by mass of the unsaturated polyester resin (B) and the ethylenically unsaturated monomer (C):
the saturated polyester resin (A) in an amount of 5 parts by mass to 30 parts by mass;
the unsaturated polyester resin (B) in an amount of 20 parts by mass to 80 parts by mass;
the ethylenically unsaturated monomer (C) in an amount of 80 parts by mass to 20 parts by mass;
the thermal polymerization initiator (D) in an amount of 0.5 parts by mass to 20 parts by mass;
the glass fiber (E) in an amount of 5 parts by mass to 150 parts by mass; and
the inorganic filler (F) in an amount of 50 parts by mass to 1000 parts by mass.

19. A molding material which is a cured product of the thermosetting resin composition according to claim 15.

20. A motor comprising:
the molded stator according to claim 9;
a rotor disposed inside the stator, the rotor including a rotary shaft configured to extend in a shaft center direction and a rotation body configured to contain a magnet component, to extend in the shaft center direction, and to be fixed to the rotary shaft; and
a bearing configured to rotatably support the rotor.
